(19) United States
(12) Patent Application Publication
(10) Pub. No.: US 2017/0002778 A1
(43) Pub. Date: Jan. 5, 2017

(54) SYSTEM AND VOLTAGE TYPE METHOD FOR TESTING AIR FLOW METER

(71) Applicant: YOW JUNG ENTERPRISE CO., LTD., KAOHSIUNG CITY (TW)

(72) Inventor: SHUN-CHI HUANG, KAOHSIUNG CITY (TW)

(21) Appl. No.: 14/789,026

(22) Filed: Jul. 1, 2015

(51) Int. Cl. F02M 35/10; G01F 25/00

(52) U.S. Cl. CPC F02M 35/10386; G01F 25/0007

(57) ABSTRACT

A system and a voltage type method for testing air flow meters are disclosed. The system includes an air feeding member, an air inlet duct connected to one end of the air feeding member, an air filter connected to one end of the air inlet duct, a throttle disposed on the air inlet duct and located in front of the air feeding member, a test fixture for fixing an object under test connected to a front end of the throttle and a flow sensor disposed between the test fixture and the air filter. The object under test is fixed for measurement. A mode of sample set-up or a mode of product comparison is selected and various items including heating curve, static voltage, floating voltage, acceleration curve, intake temperature, thermistor, atmospheric pressure, velocity curve, etc are measured in turn. Thus a voltage-type measurement procedure is complete.

### BACKGROUND OF THE INVENTION

Field of the Invention

The present invention relates to a system and a voltage type method for testing air flow meters, especially to a system and a voltage type method for testing air flow meters by which whether various brands of air flow meters conform to the standard set is tested. The test procedure allows an object under test to match the standard set.

Descriptions of Related Art

Generally fresh air flows from an air inlet, through an air filter to an engine in vehicles. The air enters the engine by passing through a throttle that controls by the driver for regulating of air entering the engine. A typical throttle body is formed by a main intake and a throttle controlled by a spring. When the driver doesn't press on the accelerator pedal, the throttle is closed and most of the air is outside the valve. When the driver presses on the accelerator pedal, the throttle cable communicated with the accelerator pedal pulls the throttle spring to activate the throttle. Thus the valve is opened to allow the air into the engine through the main intake.

Moreover, an air flow meter, also called air flow sensor, measures the change of air flow and converts the change into a voltage signal. Then the voltage signal is sent to the computer for determining the amount of fuel being injected. When an air supply system supplies clear air for engine load, and measures air quality directly and indirectly to form the best mixture with fuel sprayed by a jet nozzle. However, there is no proper test mechanism to check whether the airflow meter matches the standard set.

### SUMMARY OF THE INVENTION

Therefore it is a primary object of the present invention to provide a system and a voltage type method for testing air flow meters by which whether various brands of air flow meters comfort to the standard set is tested. The test procedure allows an object under test to match the standard set.

In order to achieve the above object, a system for testing air flow meters according to the present invention includes an air feeding member, an air inlet duct connected to one end of the air feeding member, an air filter connected to one end of the air inlet duct, a throttle disposed on the air inlet duct and located in front of the air feeding member, a test fixture for fixing an object under test connected to a front end of the throttle, and a flow sensor set between the test fixture and the air filter.

The air feeding member can be a blower.

The test fixture consists of a fixing part disposed on the air inlet duct and close to the throttle, a moveable part fitted over the air inlet duct and close to the flow sensor, a slide rail arranged with the moveable part, and a power source connected to the movable part. Driven by the power source, the moveable part is moved on the slide rail in relative to the fixing part so as to hold and fix the object under test.

Each object under test is set with a QR Code to learn test data of the object under test in a real time manner.

The voltage-type method for testing air flow meters according to the present invention includes a plurality of steps.

The object under test is fixed on the test fixture of the air flow meter test system for measurement. During the measurement, a mode of sample set-up or a mode of product comparison can be selected and various items are measured in turn to get data. The items include heating curve, static voltage, floating voltage, acceleration curve, intake temperature, thermistor, atmospheric pressure, velocity curve, etc. Thus a voltage-type measurement procedure is complete.

In a sampling program, multi-stage air flow rates are set for measurement of data at different flow rate when product information input is complete.

In a comparison program, a test mode or a lot/rework mode is selected according to the number of the air flow meters intended to be tested.

In the test mode, pick up comparison items to be measured and set parameters after product information being input. Then the data obtained is compared with the sampling data to calculate an error therebetween, and a report is printed.

In the lot/rework mode, serial number of the lot is input after input of product information. Then pick up comparison items to be measured and set parameters. The data obtained is compared with the sampling data, an error therebetween is calculated, and a report is printed.

In the lot/rework mode, the data obtained of the air flow meter with different serial number measured is saved after statistics and analysis. Then a final report is output.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is a partial perspective view of an embodiment viewed from another angle according to the present invention;

FIG. 3 is a schematic drawing showing an object under test being mounted into an embodiment according to the present invention;

FIG. 4 is a schematic drawing showing an embodiment in use according to the present invention;

FIG. 5A is a block diagram I showing steps of an embodiment according to the present invention;

FIG. 5B is a block diagram II showing steps of an embodiment according to the present invention;

FIG. 5C is a block diagram III showing steps of an embodiment according to the present invention;

FIG. 6 shows data in a comparison program displayed on a screen of an embodiment according to the present invention;

FIG. 7 shows data in a sampling program displayed on a screen of an embodiment according to the present invention.

### DETAILED DESCRIPTION OF THE PREFERRED EMBODIMENT

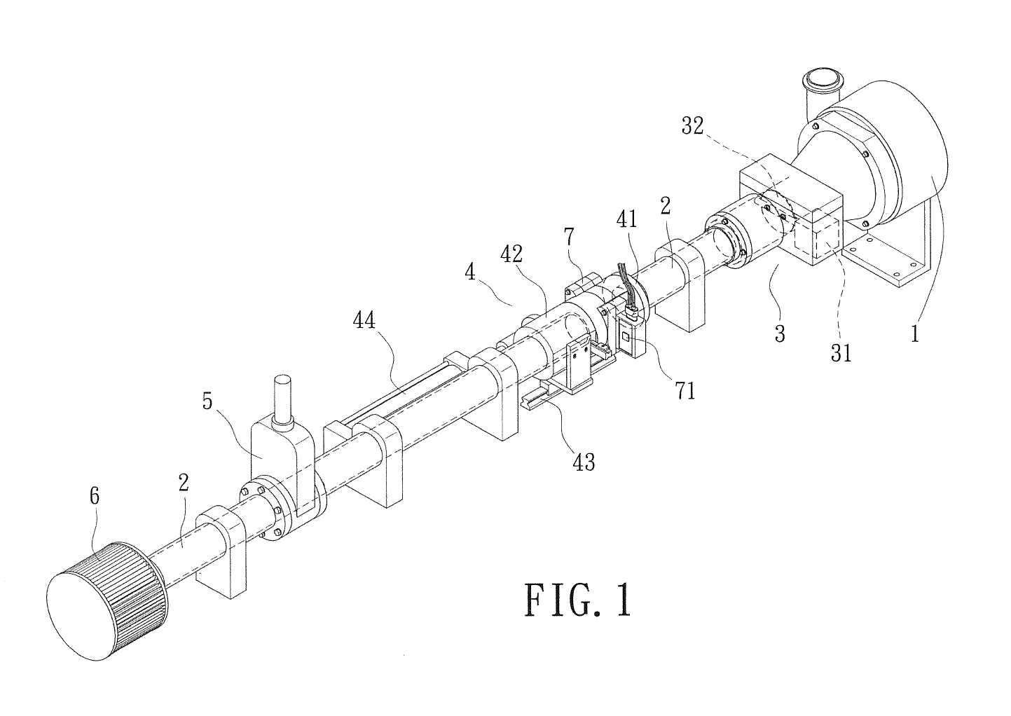

Refer to FIG. 1, an air flow meter test system of the present invention mainly includes an air feeding member 1, an air inlet duct 2, a throttle 3, a test fixture 4, a flow sensor 5, and an air filter 6. The air inlet duct 2 is connected to the air feeding member 1 and used for delivering air. The throttle 3 is disposed adjacent to the air feeding member 1, located on the air inlet duct 2 and used for control of the amount of air intake. The test fixture 4 is arranged adjacent to the throttle 3, located on the air inlet duct 2 and used to fix and hold an object under test 7. The flow sensor 5 is set adjacent to the test fixture 4, located on the air inlet duct 2 and used for detecting air flow data of the object under test 7. The air filter 6 is mounted at a rear end of the air inlet duct 2 and used for filtering the air intake.

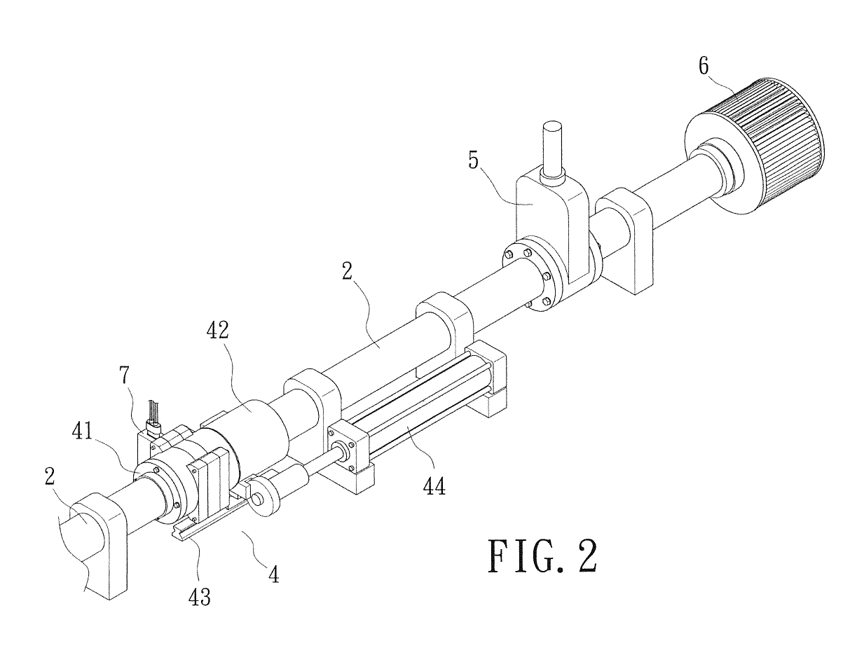

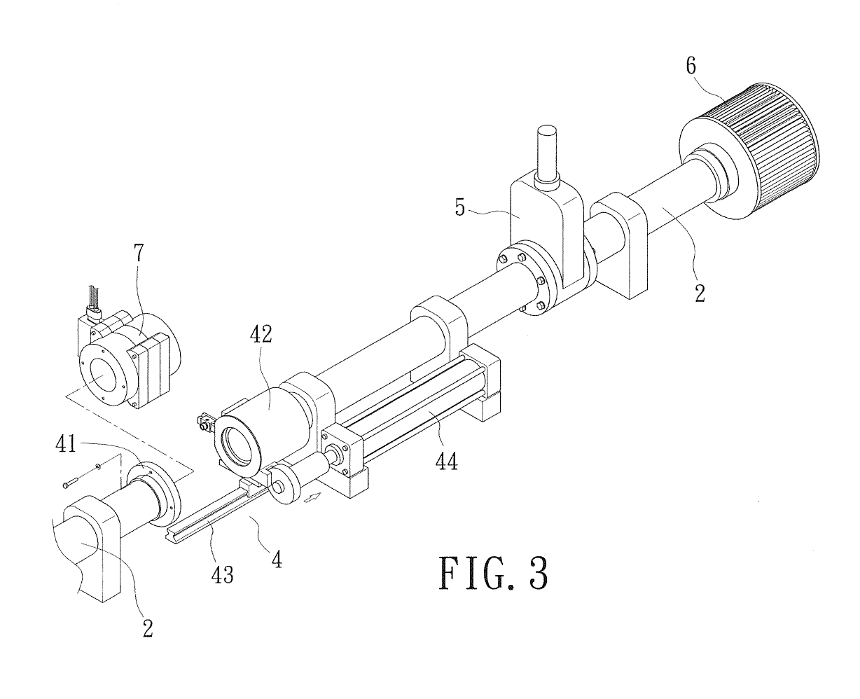

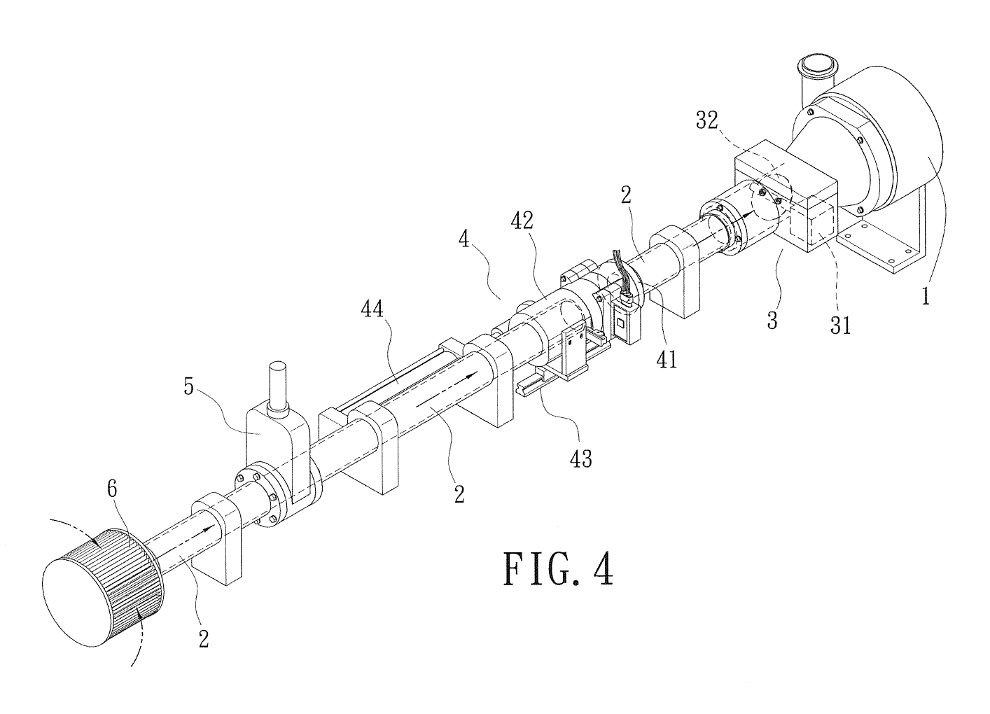

Refer from FIG. 1 to FIG. 4, the object under test 7 is fixed on the test fixture 4. The test fixture 4 further includes a fixing part 41, a moveable part 42, a slide rail 43 and a power source 44. The fixing part 41 is disposed on the air inlet duct 2 and close to the throttle 3. The moveable part 42 is fitted over the air inlet duct 2 and close to the flow sensor 5 and arranged at the slide rail 43. The moveable part 42 is further connected to the power source 44. Driven by the power source 44, the moveable part 42 is moved on the slide rail 43 in relative to the fixing part 41 so as to hold and fix the object under test 7.

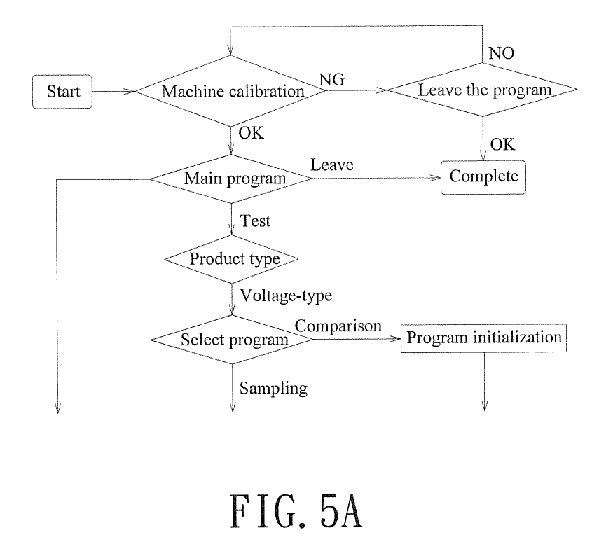

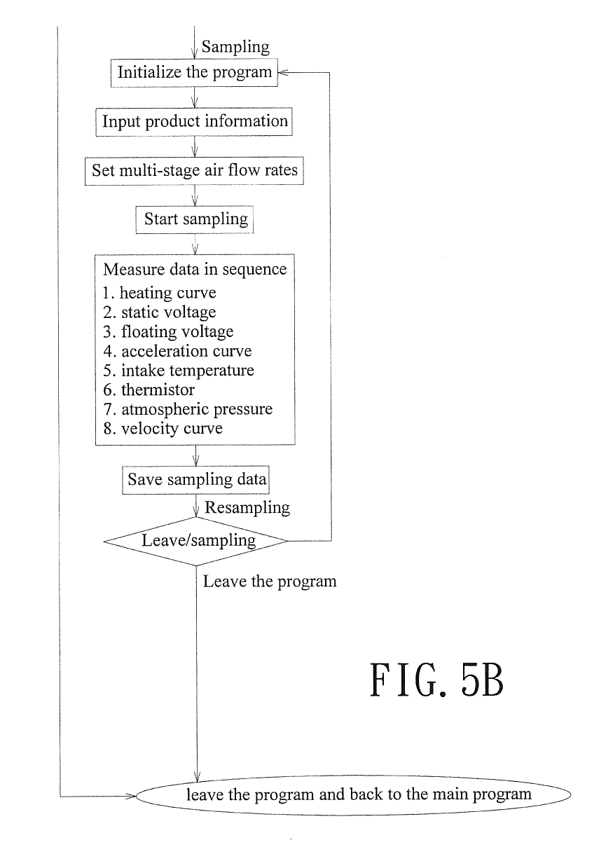

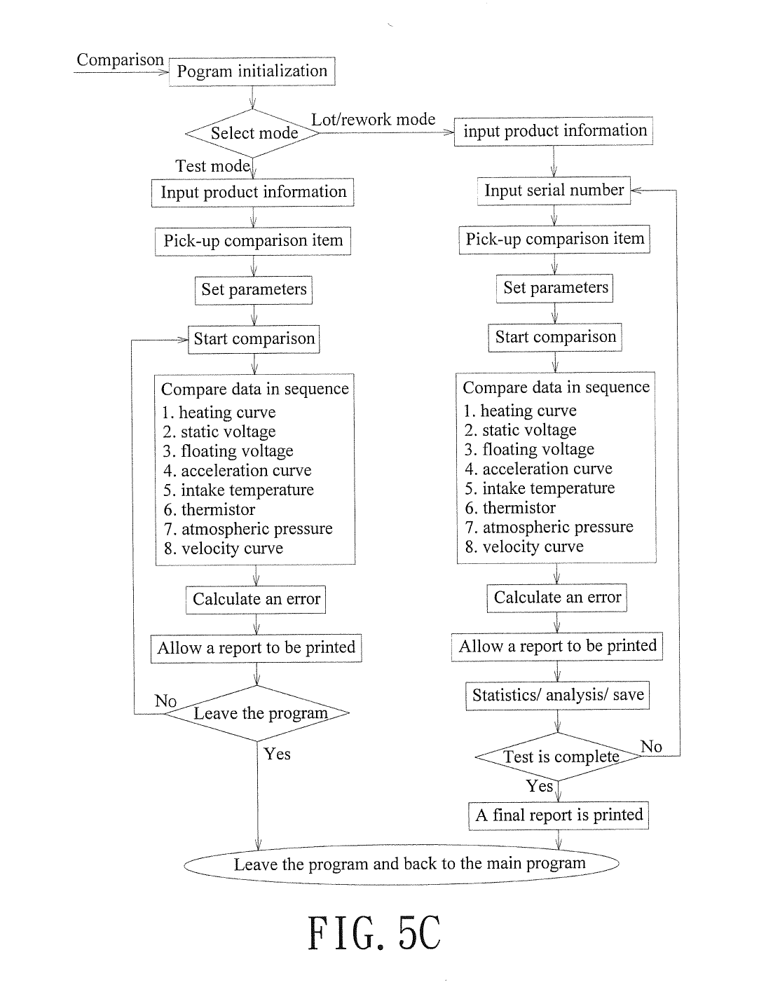

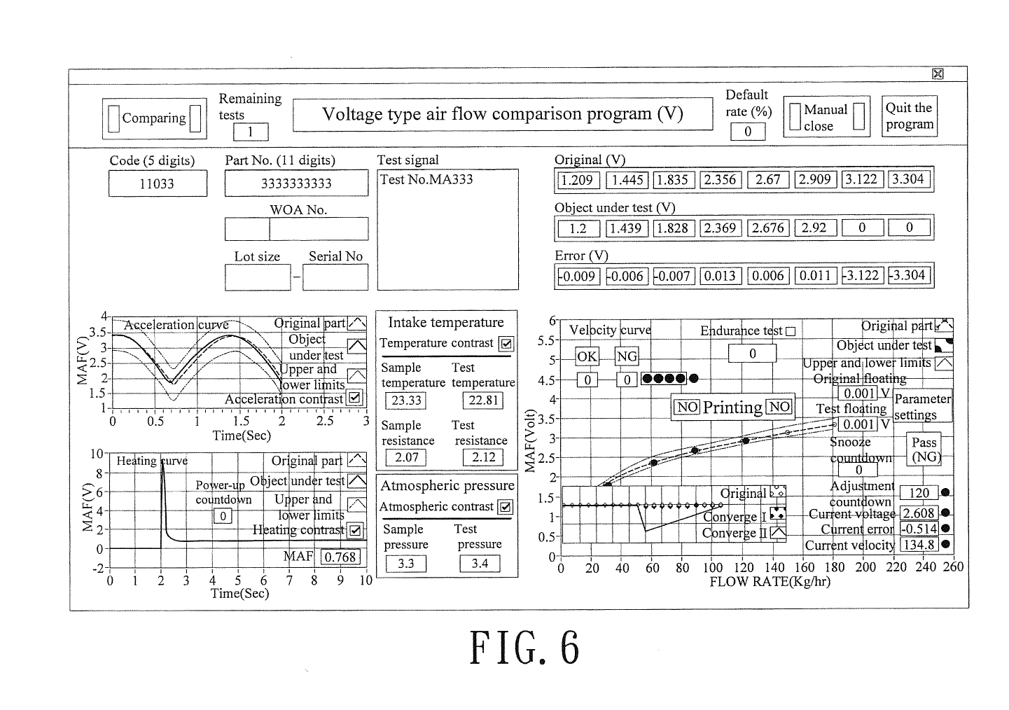

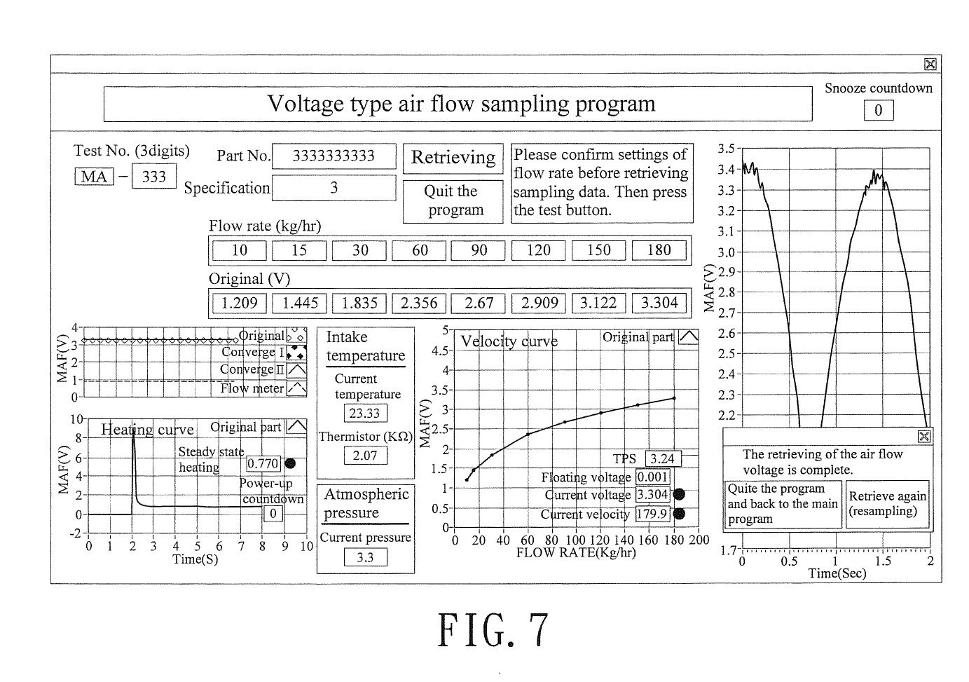

Refer to FIG. 5A-5C, FIG. 6, and FIG. 7, the air flow detector with the object under test 7 held therein is connected to a computer control system (not shown in the figures). Please refer to FIG. 5A, while starting the measurement, users select to execute a sampling program or a comparison program according to the object under test 7. If the object under test 7 is a new air flow sensor with new specification, the sampling program is selected (please refer to FIG. 5B). If the computer control system already has sampling data of object with the same specification, the comparison program is chosen. In the sampling program, first the program is initialized, product data of the object under test 7 is input into the computer control system. Then multi-stage air flow rates are set for measuring data at different flow rate. Next start sampling. The air feeding member 1 works to deliver air into the air inlet duct 2 through the end of the air inlet duct 2 with the air filter 6. At the same time, a vane 32 of the throttle 3 is opened under control of a motor 31. The opened degree of the vane 32 is corresponding to the amount of air entering the engine. Then the flow rate of the object under test 7 is measured by the flow sensor 5. Various items of the sample include heating curve, static voltage, floating voltage, acceleration curve, intake temperature, thermistor, atmospheric pressure, velocity curve are measured in sequence to get data. The vehicle performance and safety is affected by these measurement items.

| Measure- | | | |
|---|---|---|---|
| ment | Purpose of | Main function in | |
| item | measurement | vehicle | Abnormal result |
| Heating | Test and get | PT is heated | The incorrect or |
| curve | PT transient | instantly at high | unstable voltage |
| | heating data | temperature so that | output will lead to |
| | and curve of | foreign matter | increasing fuel |
| | the PT pad set | attached to PT | consumption, |
| | when a voltage | such as hair, | engine torque |
| | is applied. | dander) is melted. | loss, or shaking. |
| | | | In serious cases, |
| | | | the check light of |
| | | | engine's exhaust |
| | | | system is on and |
| | | | the trouble code |
| | | | is displayed. |
| Static | Test whether | After the PT being | Quickly start the |
| voltage | the voltage | heated instantly at | engine. The |
| | output after | high temperature | engine is vibrated |
| | heating is | for a period for | and failed due to |
| | within a | time, the voltage | abnormal output |
| | reasonable | output is within a | of the static |
| | range. | normal range. | voltage. In serious |
| | | | cases, the check |
| | | | light of engine's |
| | | | exhaust system is |
| | | | on and the trouble |
| | | | code is displayed. |
| Floating | Detect whether | The trip computer | When the voltage |
| voltage | the noise and | receives the | floats too much |
| | stability are | voltage to adjust | (due to noise), the |
| | acceptable | engine control | engine is |
| | when a voltage | signals such as | indirectly vibrated |
| | is applied. | IAC (idle air | because of the |
| | | control) or ETC | voltage signal the |
| | | (electronic throttle | trip computer |
| | | control) before and | receives. In |
| | | after the engine | serious cases, the |
| | | being started. | check light of |
| | | | engine's exhaust |
| | | | system or fuel |
| | | | system is on and |
| | | | related trouble |
| | | | code is displayed. |
| Acceleration | Simulate | The curve is used | Poor acceleration |
| curve | sudden | to learn sudden | during uphill |
| | acceleration/ | acceleration/ | climbing or high |
| | deceleration of | deceleration, | speed running, or |
| | vehicles and | acceleration | late kick-down |
| | test response | performance on | results in poor |
| | speed of the | uphill road with | drivability, and |
| | product | heavy load or | shift vibration. |
| | | during high speed | |
| | | running, and time | |
| | | for control of | |
| | | kick-down of the | |
| | | vehicle. | |
| Intake | Measure and | To confirm that the | Inconsistent |
| temperature | record the | ambient | ambient |
| | intake | temperature of the | temperature in the |
| | temperature | sampling program | sampling program |
| | | and that of the | and the |
| | | comparison | comparison |
| | | program in the | program of the |
| | | airflow test | airflow test |
| | | machine are | machine can |
| | | consistent. | cause errors in the |
| | | | system. Thus the |
| | | | engine vibration |
| | | | occurs or the |
| | | | check engine light |
| | | | is on |
| Thermistor | Test the | The trip computer | The signal |
| | thermistor | receives the | adjustment results |
| | function | voltage, converts | in too much/little |
| | | the voltage into | fuel injected. The |
| | | intake temperature | check engine light |
| | | of intake manifold | is on and the |
| | | and carries out fine | trouble code |
| | | adjustment of the | related to the |
| | | signal for control | intake system is |
| | | of the amount of | displayed. |
| | | fuel injected | |
| | | according to | |
| | | difference in | |
| | | ambient | |
| | | temperature. | |
| Atmospheric | Detect | The trip computer | The adjustment |
| pressure | atmospheric | receives the | causes too |
| | pressure | voltage and adjusts | much/little fuel |
| | | the signal for | injected, easy |
| | | control of the | flame out at idle, |
| | | amount of fuel | the difficulty in |
| | | injected and | start up, and |
| | | engine RPM | engine torque loss |
| | | controlled by IAC | in high mountain. |
| | | (idle air control)/ | In serious cases, |
| | | ETC (electronic | the check engine |
| | | throttle control) | light is on and the |
| | | due to difference | trouble code |
| | | in atmospheric | related to the |
| | | pressure (air | intake system is |
| | | concentration). | displayed. |
| Velocity | Simulate road | The trip computer | Thus start, idle, |
| curve | running and | receives the | air conditioning |
| | test signals | voltage signal | operation, and |
| | corresponding | (frequency) and | road driving are |
| | to idle/in gear/ | controls the | all not smooth. |
| | air | amount of air | Other problems |
| | conditioner/ | entering the engine | including too |
| | low/ | at start, idle, | much/little fuel |
| | medium-low/ | low/medium/high | injected, and a |
| | medium/ | speed. Thus | shorter/longer |
| | medium- | engine's fuel | burn time also |
| | high/high | injected, ignition | occur. In serious |
| | speed. | time, and gear | cases, the engine |
| | | change time are | check light is on |
| | | further controlled. | and the trouble |
| | | | codes related to |
| | | | the intake/exhaust |
| | | | system and the |
| | | | engine are |
| | | | displayed. |

After the measurement, the sampling data obtained is stored. If no sample is taken again, leave the program. If the user wants to sample again, resampling is selected and the above steps are repeated.

When the standard data of the air flow meter with the same specification of the object under test 7 has been built-up by the sampling program, the comparison program is selected and data is retrieved from the system for comparison and measurement. Please refer to FIG. 5C, in the comparison program, a test mode or a lot/rework mode is selected according to the number of the objects under test 7. When there is a single object under test 7, the test mode is selected. Then product information of the object under test 7 is input. The comparison items are picked up according to the items of the flow rate required to be measured and parameters are set. Next start comparison. Similarly, the air feeding member 1 works to deliver air into the air inlet duct 2 through the end of the air inlet duct 2 with the air filter 6. At the same time, the vane 32 of the throttle 3 is opened under control of the motor 31. The opened degree of the vane 32 is corresponding to the amount of air entering the engine. Then the flow rate of the object under test 7 is measured by the flow sensor 5. Various items of the sample including heating curve, static voltage, floating voltage, acceleration curve, intake temperature, thermistor, atmospheric pressure, velocity curve are measured in sequence to get data. The purpose of measurement, function and abnormal result are as mentioned above. Then the data obtained is compared with the sampling data and an error therebetween is calculated to allow a report to be printed. After the printing of the report, leave the program if the user will not make comparisons in the test mode again. Once the user wants to make comparisons in the test mode again, “to compare again” is selected and the above steps are repeated.

Please refer to FIG. 5C, when the object under test 7 is in a great quantity, the lot/rework mode is selected. Then product information and serial number of the object under test 7 is input. The comparison items are picked up according to the measurement items of the flow velocity required to be measured and parameters are set. Next start comparison. In a similar way, the air feeding member 1 works to deliver air into the air inlet duct 2 through the end of the air inlet duct 2 with the air filter 6. The vane 32 of the throttle 3 is simultaneously opened under control of the motor 31. The opened degree of the vane 32 is corresponding to the amount of air entering the engine. Then the flow rate of the object under test 7 is measured by the flow sensor 5. Various items of the sample include heating curve, static voltage, floating voltage, acceleration curve, intake temperature, thermistor, atmospheric pressure, velocity curve are measured in sequence to get data. Then the data obtained is compared with the sampling data and an error therebetween is calculated to allow a report to be printed. Then this piece of data is recorded and saved after statistics and analysis. Print a final report and leave the program if the user will not make comparisons again in the lot/rework mode. Once the user wants to make comparisons in the lot/rework mode again, “to compare again” is selected and the above steps are repeated.

In addition, no matter the data on flow rate of the object under test 7 measured matches test standard or not, the data will be recorded in relation to the serial number. Each object under test 7 is further arranged with a QR Code 71 so as to get the measured data on flow rates of the object under test 7 in a real time manner. Moreover, the QR Code 71 can also be retrieved by adjustment equipment and used as a base for data adjustment when the data on flow rates of the object under test 7 doesn't match the test standard.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A system for testing air flow meters comprising:
an air feeding member;
an air inlet duct connected to the air feeding member and used for air intake;
a throttle disposed adjacent to the air feeding member, located on the air inlet duct and used for control of the amount of the air intake;
a test fixture arranged adjacent to the throttle, located on the air inlet duct and used to fix an object under test;
a flow sensor set adjacent to the test fixture, located on the air inlet duct and used for measuring air flow data of the object under test; and
an air filter mounted at a rear end of the air inlet duct and used for filtering the air intake.

2. The system as claimed in claim 1, wherein the test fixture includes a fixing part disposed on the air inlet duct and close to the throttle, a moveable part fitted over the air inlet duct and close to the flow sensor, a slide rail arranged with the moveable part, and a power source connected to the movable part; the moveable part is driven by the power source to move on the slide rail in relative to the fixing part so as to hold and release the object under test.

3. The system as claimed in claim 1, wherein the object under test is arranged with a QR Code so as to get data of the object under test in a real time manner.

4. The system as claimed in claim 2, wherein the object under test is arranged with a QR Code so as to get data of the object under test in a real time manner.

5. A voltage-type method for testing an air flow meter and getting data of air flow of the air flow meter by voltage comprising the steps of:
selecting a sampling program/or a comparison program;
inputting product information;
starting sampling/or comparison to measure items including heating curve, static voltage, floating voltage, acceleration curve, intake temperature, thermistor, atmospheric pressure, velocity curve in turn and obtain data of the items; and
storing and printing the data.

6. The method as claimed in claim 5, wherein the method further includes a step of setting multi-stage air flow rates to measure data at each of the air flow rates in the sampling program after the step of inputting product information.

7. The method as claimed in claim 5, wherein the method further includes a step of selecting a test mode or a lot/rework mode according to the number of the air flow meters to be tested in the comparison program.

8. The method as claimed in claim 7, wherein after the step of inputting product information, the method further includes a step of picking up at least one item to be measured and compared, setting parameters, calculating an error between the data of the item obtained and sampling data, and printing a report in the test mode.

9. The method as claimed in claim 7, wherein after the step of inputting product information, the method further includes a step of inputting serial number of a lot of the air flow meters; picking up at least one item to be measured and compared, setting parameters; calculating an error between the data of the item obtained and sampling data, and printing a report in the lot/rework mode.

10. The method as claimed in claim 9, wherein the method further includes a step of saving the data of the item obtained of the air flow meter with the serial number after statistics and analysis, and outputting a final report in the lot/rework mode.
